(19) United States
(12) Patent Application Publication
(10) Pub. No.: US 2026/0056360 A1
(43) Pub. Date: Feb. 26, 2026

(54) PREPARATION METHOD AND STRUCTURE OF MICROLENSES AT WAVEGUIDE SIDE

(71) Applicant: FOCI FIBER OPTIC COMMUNICATIONS, INC., HSINCHU (TW)

(72) Inventors: Ting-Ta Hu, HSINCHU (TW); Po-Yi Wu, HSINCHU (TW); Chieh-Yu Fang, HSINCHU (TW); Ting-Yan Lin, HSINCHU (TW)

(21) Appl. No.: 18/947,128

(22) Filed: Nov. 14, 2024

(30) Foreign Application Priority Data
Aug. 20, 2024 (TW) 113131360

(51) Int. Cl. G02B 6/122; G02B 6/13

(52) U.S. Cl. CPC G02B 6/122; G02B 6/13

(57) ABSTRACT

The present invention relates to a preparation method and structure of multi-layer stacked waveguide. The method involves providing an optical waveguide block; forming an optical lens groove in the optical waveguide block; forming an anti-reflection layer to cover the optical waveguide block and the optical lens groove; forming an optical lens material above the optical waveguide block and filling the optical lens groove; removing portions of the anti-reflective layer and the optical lens material to define a preliminary microlens structure; and performing a reflow process on the preliminary microlens structure to form a microlens.

### CROSS-REFERENCE TO RELATED APPLICATION

This application claims the priority of Taiwanese patent application No. 113131360, filed on Aug. 20, 2024, which is incorporated herewith by reference.

### BACKGROUND OF THE INVENTION

### 1. Field of the Invention

The present invention relates generally to a technical field of microlenses, and in particular to a preparation method and structure of microlens at waveguide side.

### 2. The Prior Arts

Optical waveguides usually need to use lenses where beam steering is required. However, since the size of the optical waveguide block and the optical waveguide is very small, it is currently necessary to use an adapter to steer the beam, which not only increases the overall size, but also makes it difficult to align the beam to achieve steering and continuous transmission.

### SUMMARY OF THE INVENTION

A primary objective of the present invention is to provide a preparation method of microlenses at waveguide side, which can form microlens at the light exit surface of the optical waveguide directly, and divert the light beam from the light exit surface of the optical waveguide to the bottom of the optical lens groove and facing downward, which means that the light beam transmitted in the parallel direction turns to the light beam transmitted downward, thereby achieving a small size and easy alignment of the beam for continuous transmission.

In order to achieve the aforementioned objective, the present invention provides a preparation method of microlenses at waveguide side, including: providing an optical waveguide block; forming an optical lens groove in the optical waveguide block; forming an anti-reflection layer to cover the optical waveguide block and the optical lens groove; forming an optical lens material above the optical waveguide block and filling the optical lens groove; removing the anti-reflective layer and the optical lens material outside the one side of the optical lens groove and above the optical waveguide block and adjacent to the side of the optical lens groove to define a microlens preliminary structure; and performing a reflow process on the microlens preliminary structure to form a microlens.

In some embodiments, the optical waveguide block has a plurality of optical waveguides.

In some embodiments, a central axis of the optical lens groove is perpendicular to a central axis of each optical waveguide.

In some embodiments, the optical lens groove is formed such that a light exit surface of the optical waveguides is exposed at the optical lens groove.

In some embodiments, the optical lens material is a transparent or high transmittance organic polymer material.

In some embodiments, the optical lens material is a polymer or photoresist.

In some embodiments, the anti-reflective layer is formed by coating.

In some embodiments, the optical lens material is formed by coating.

In some embodiments, the microlens has a curvature such that one end of the microlens corresponds to each optical waveguide, and the other end of the microlens corresponds to a bottom in the optical lens groove.

In some embodiments, the curvature is controlled by the temperature and time of heating.

The present invention also provides a structure of microlenses at waveguide side, including an optical waveguide block with at least one optical lens groove, and a microlens formed on one side of the optical lens groove using the aforementioned preparation method.

In order to make the above objects, features and advantages of the present invention more obvious and easy to understand, the specific embodiments listed in the drawings are described in detail below.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart of a preparation method of microlenses at waveguide side of the present invention.

FIG. 2 is a schematic diagram of a structure in preparation method of microlenses at waveguide side of the present invention.

FIG. 3 is a schematic diagram of a structure in the preparation method of microlenses at waveguide side of the present invention.

FIG. 4 is a schematic diagram of a structure in the preparation method of microlenses at waveguide side of the present invention.

FIG. 5 is a schematic diagram of a structure in the preparation method of microlenses at waveguide side of the present invention.

FIG. 6 is a schematic diagram of a structure in the preparation method of microlenses at waveguide side of the present invention.

FIG. 7 is a schematic diagram of a structure in the preparation method of microlenses at waveguide side of the present invention.

FIG. 8 is a schematic diagram showing the curve of the curvature of the microlens corresponding to the temperature in the preparation method of microlens at waveguide side of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

The accompanying drawings are included to provide further understanding of the invention, and are incorporated in and constitute a part of this specification. The drawings illustrate embodiments of the invention and, together with the description, serve to explain the principles of the invention.

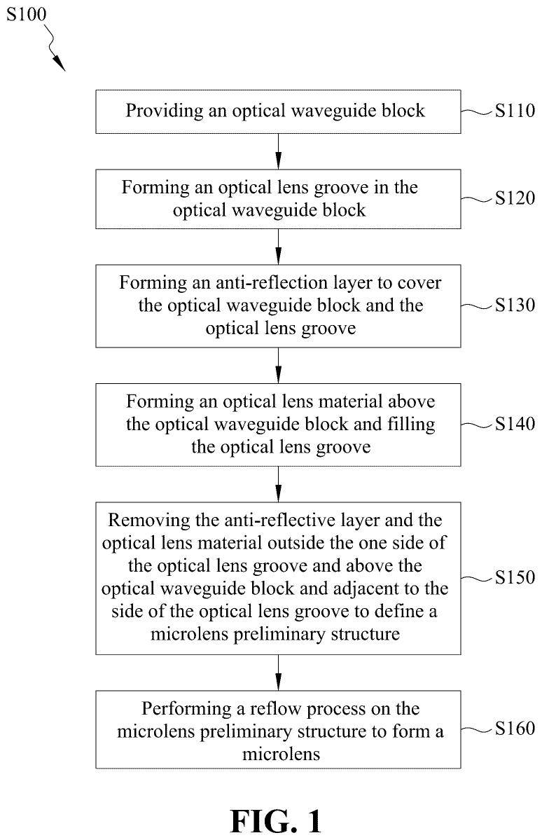

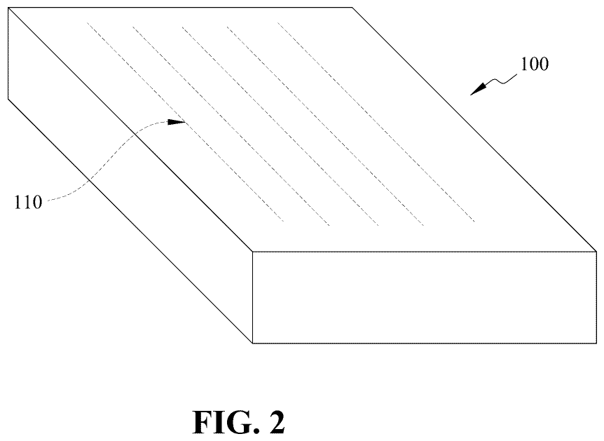

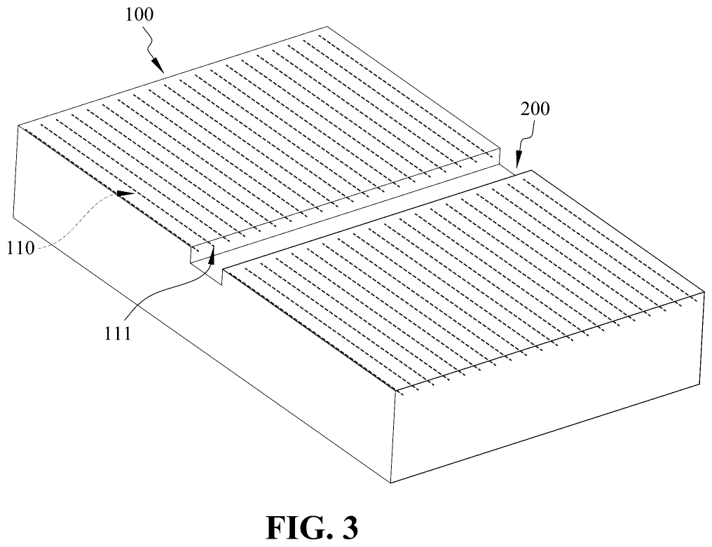

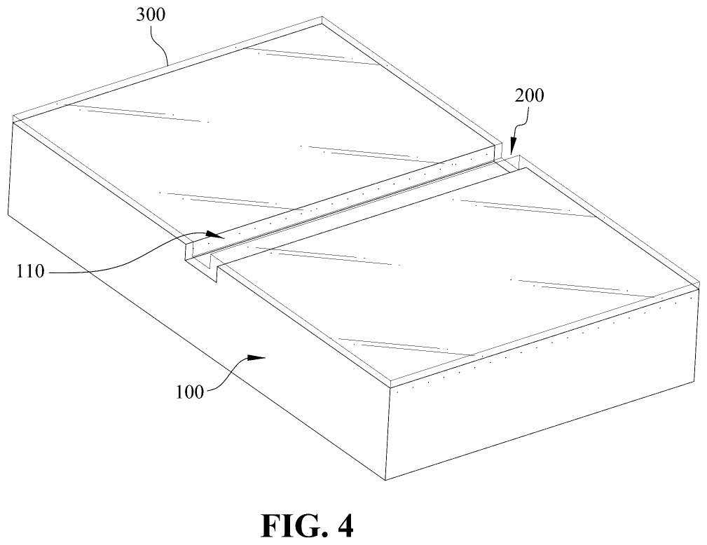

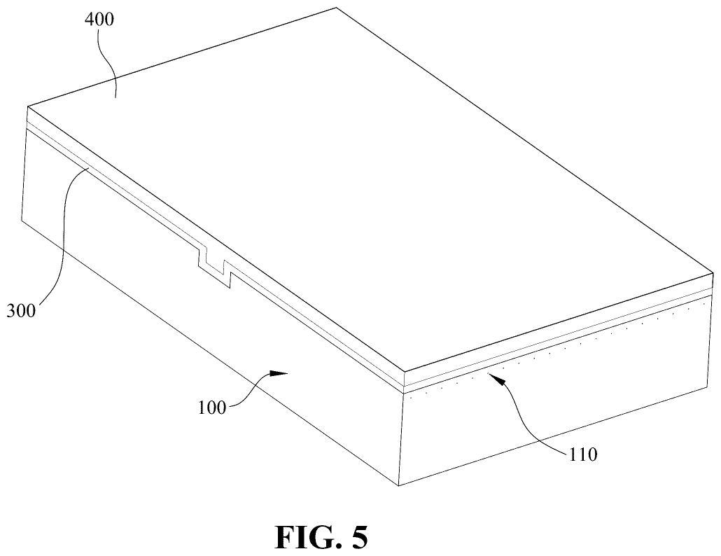

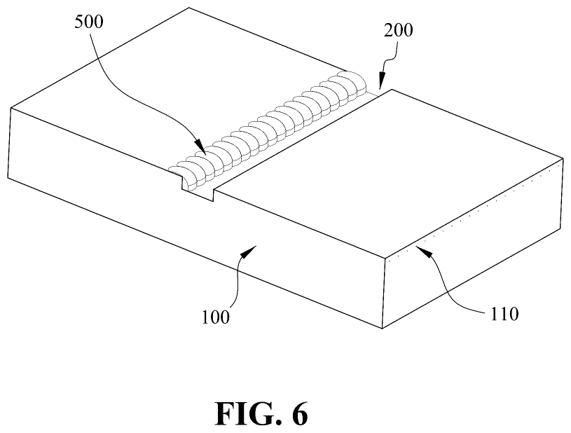

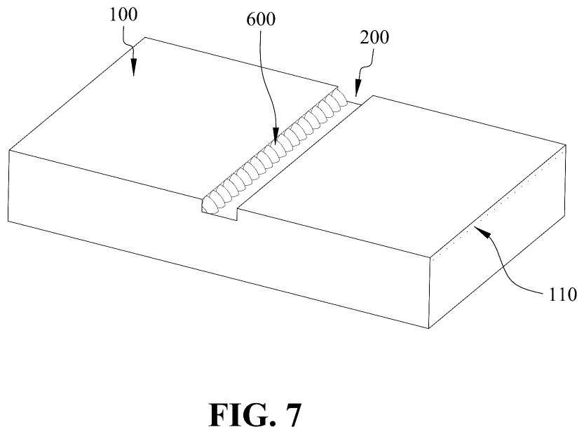

FIG. 1 is a flow chart of a preparation method of microlenses at waveguide side of the present invention; FIG. 2 is a schematic diagram of a structure in preparation method of microlenses at waveguide side of the present invention; FIG. 3 is a schematic diagram of a structure in the preparation method of microlenses at waveguide side of the present invention; FIG. 4 is a schematic diagram of a structure in the preparation method of microlenses at waveguide side of the present invention; FIG. 5 is a schematic diagram of a structure in the preparation method of microlenses at waveguide side of the present invention; FIG. 6 is a schematic diagram of a structure in the preparation method of microlenses at waveguide side of the present invention; and FIG. 7 is a schematic diagram of a structure in the preparation method of microlenses at waveguide side of the present invention.

Refer to FIGS. 1 to 6. The preparation method S100 of microlenses at waveguide side according to the present invention includes steps S110 to S160.

Refer to FIG. 1 and FIG. 2. In step S110, an optical waveguide block 100 is provided. In some embodiments, optical waveguide block 100 includes a plurality of optical waveguides 110. In some embodiments, the optical waveguides 110 are parallel to each other and spaced apart from each other inside the optical waveguide block 100.

Refer to FIG. 1 and FIG. 3. In step S120, an optical lens groove 200 is formed in the optical waveguide block 100. In some embodiments, the formation of the optical lens groove 200 may include cutting, etching, or other methods, but is not limited thereto. In some embodiments, a central axis of the optical lens groove 200 is perpendicular to a central axis of each optical waveguide 110. Therefore, the optical lens groove 200 is formed such that a light exit surface 111 of each optical waveguide 110 is exposed at the optical lens groove 200.

Refer to FIG. 1 and FIG. 4. In step S130, an anti-reflection layer 300 is formed to cover the optical waveguide block 100 and the optical lens groove 200. In some embodiments, the anti-reflection layer can be formed by coating, but is not limited thereto.

Refer to FIG. 1 and FIG. 5. In step S140, an optical lens material 400 is formed above the optical waveguide block 100 and fills the optical lens groove 200. In some embodiments, the formation of the optical lens material 400 can be achieved by coating, but is not limited thereto. In some embodiments, the optical lens material 400 can be a transparent or high transmittance organic polymer material. For example, the optical lens material 400 can be a polymer or a photoresist, but is not limited thereto.

Refer to FIG. 1 and FIG. 6. In step S150, remove the reflective layer 300 and the optical lens material 400 outside of one side of the optical lens groove 200 and above the optical waveguide block 100 and adjacent to the side of the optical lens groove 200 so as to define a microlens preliminary structure 500. In the present embodiment, the microlens preliminary structure 500 is formed at the side of the optical lens groove 200 and the area above the optical fiber adjacent to the side of the waveguide block 100 is not limited thereto. The microlens preliminary structure 500 can also be formed only an a large area on the side of the optical lens groove 200. Therefore, the shape of the microlens preliminary structure 500 is not fixed. The shape is used to match the subsequent reflow step, making it easy to form the required curvature shape subsequently, but the appearance shape is generally an arc surface. In some embodiments, the removal operation may be an exposure, development or etching operation, but is not limited thereto.

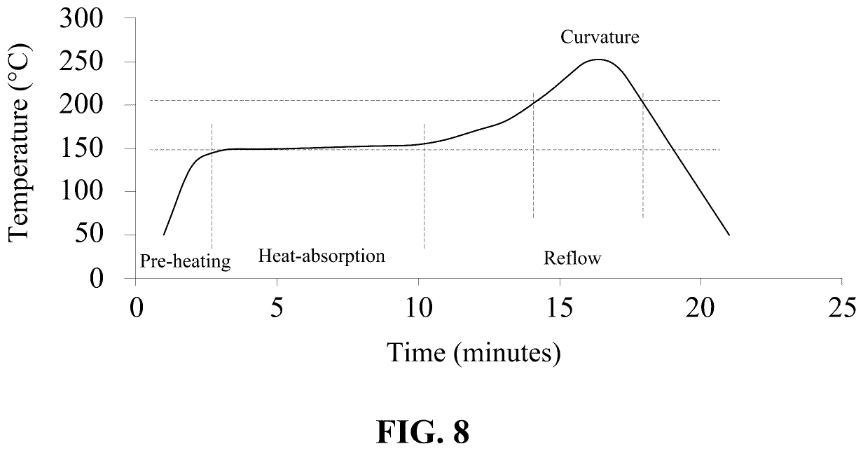

Refer to FIGS. 1, 7 and 8. In step S160, a reflow process is performed on the preliminary microlens structure 500 to form a microlens 600. In the present embodiment, the microlens must have a curvature, as shown in FIG. 8, which indicates that the heating temperature has a corresponding relationship with time (minutes), which means that the required curvature can be obtained under the reflow process. Because the curvature can be controlled by heating temperature and heating time, that is to say, if different curvatures are required, the process can be adjusted to achieve the target curvature, such as, using different heating temperatures and different heating times. One end of the formed microlens 600 corresponds to each optical waveguide 110 (i.e., the light exit surface 111), and the other end of the microlens 600 corresponds to a bottom in the optical lens groove 200. The microlens 600 is formed from the optical waveguide 110 (i.e., the light exit surface 111). The emitted light beam is diverted to the bottom of the optical lens groove 200 by the microlens 600.

Refer to FIG. 7. The structure of microlens at waveguide side according to the present invention may include an optical waveguide block 100 with at least one optical lens groove 200. The aforementioned preparation method S100 is used on one side of the optical lens groove 200 (i.e., such as the light exit surface 111 shown in FIG. 3 forms a microlens 600.

In summary, the preparation method S100 and structure of microlens at waveguide side according to the present invention can form the microlens 600 at the light exit surface 111 of the optical waveguide 110 directly, and diverting the light beam from the light exit surface 111 of the optical waveguide 110 to the bottom of the optical lens groove 200 to face downward, which means that the light beam transmitted in the parallel direction is turned into the light beam transmitted downward, thereby achieving a small size and easy alignment of the light beam for continuous transmission.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A preparation method of microlenses at waveguide side, comprising the steps of:
providing an optical waveguide block;
forming an optical lens groove in the optical waveguide block;
forming an anti-reflection layer to cover the optical waveguide block and the optical lens groove;
forming an optical lens material above the optical waveguide block and filling the optical lens groove;
removing the anti-reflective layer and the optical lens material outside the one side of the optical lens groove and above the optical waveguide block and adjacent to the side of the optical lens groove to define a microlens preliminary structure; and
performing a reflow process on the microlens preliminary structure to form a microlens.

2. The preparation method of microlenses at waveguide side according to claim 1, wherein the optical waveguide block has a plurality of optical waveguides.

3. The preparation method of microlenses at waveguide side according to claim 2, wherein a central axis of the optical lens groove is perpendicular to a central axis of each optical waveguide.

4. The preparation method of microlenses at waveguide side according to claim 3, wherein the optical lens groove is formed in a manner that a light exit surface of the optical waveguides is exposed at the optical lens groove.

5. The preparation method of microlenses at waveguide side according to claim 1, wherein the optical lens material is a transparent or high transmittance organic polymer material.

6. The preparation method of microlenses at waveguide side according to claim 1, wherein the optical lens material is a polymer or photoresist.

7. The preparation method of microlenses at waveguide side according to claim 1, wherein the anti-reflective layer is formed by coating.

8. The preparation method of microlenses at waveguide side according to claim 1, wherein the optical lens material is formed by coating.

9. The preparation method of microlenses at waveguide side according to claim 4, wherein the microlens has a curvature such that one end of the microlens corresponds to each optical waveguide, and the other end of the microlens corresponds to a bottom in the optical lens groove.

10. The preparation method of microlenses at waveguide side according to claim 9, wherein the curvature is controlled by the temperature and time of heating.

11. A structure of microlenses at waveguide side, comprising an optical waveguide block with at least one optical lens groove, and a microlens formed on one side of the optical lens groove by the preparation method of microlenses at waveguide side according to claim 1.
